(19) United States
(12) Patent Application Publication
(10) Pub. No.: US 2026/0064277 A1
(43) Pub. Date: Mar. 5, 2026

(54) NAMESPACE DATA SEGREGATION IN A MULTI-NAMESPACE MEMORY DEVICE

(71) Applicant: Microchip Technology Incorporated, Chandler, AZ (US)

(72) Inventors: Saswati Das, Milpitas, CA (US); Nian Niles Yang, Mountain View, CA (US); Srinivas Yelisetti, Fremont, CA (US); Luke Anthony Johnson, Queen Creek, AZ (US)

(73) Assignee: Microchip Technology Incorporated, Chandler, AZ (US)

(21) Appl. No.: 18/967,246

(22) Filed: Dec. 3, 2024

Related U.S. Application Data
(60) Provisional application No. 63/687,629, filed on Aug. 27, 2024.

(51) Int. Cl. G06F 3/06

(52) U.S. Cl. CPC G06F 3/0611; G06F 3/0652; G06F 3/0679

(57) ABSTRACT

A data storage system includes a memory device and a controller. The memory device includes a plurality of wordlines. The controller includes processor(s) and a memory. The memory includes instructions, that when executed the processor(s), cause the processor(s) to: identify, from incoming data, a plurality of namespace identifiers (IDs) corresponding to a plurality of namespaces; segregate the incoming data according to the plurality of namespace IDs; and write the segregated incoming data to respective ones of the plurality of wordlines.

### CROSS-REFERENCE TO RELATED APPLICATIONS

The current patent application claims the benefit under 35 U.S.C. § 119(e) of the priority date of U.S. Provisional Application Ser. No. 63/687,629; titled “NAMESPACE DATA SEGREGATION TO ENABLE EFFICIENT DATA HANDLING AND SECURE ERASE IN MULTI-NAMESPACE SSD”; and filed August 27, 2024. The Provisional Application is hereby incorporated by reference, in its entirety, into the current patent application.

### TECHNICAL FIELD

Various examples of the present disclosure relate to namespace data segregation to enable efficient data handling and secure erase operations and a multi-namespace memory device.

### BACKGROUND

A typical solid state drive (SSD) controller for a multi-namespace SSD may write data for each namespace as the data is received. The data may be written to wordlines of a virtual block. Accordingly, one wordline may contain data associated with data having different formats corresponding to respective namespaces. As a result, write amplification and latency may be increased when data for a particular namespace is to be erased.

This background discussion is intended to provide information related to the present invention which is not necessarily prior art.

### SUMMARY OF THE INVENTION

According to various examples of the present disclosure, non-transitory computer readable media may include instructions stored thereon, that when executed by at least one processor, cause the at least one processor to: identify, from incoming data, a plurality of namespace identifiers (IDs) corresponding to a plurality of namespaces; segregate the incoming data according to the plurality of namespace IDs; and write the segregated incoming data to respective ones of a plurality of wordlines of a memory device.

According to various examples of the present disclosure, a data storage system includes a memory device and a controller. The memory device includes a plurality of wordlines. The controller includes processor(s) and a memory. The memory includes instructions, that when executed the processor(s), cause the processor(s) to: identify, from incoming data, a plurality of namespace identifiers (IDs) corresponding to a plurality of namespaces; segregate the incoming data according to the plurality of namespace IDs; and write the segregated incoming data to respective ones of the plurality of wordlines.

According to various examples of the present disclosure, a computer-implemented method may include: identifying, from incoming data, a plurality of namespace identifiers (IDs) corresponding to a plurality of namespaces; segregating the incoming data according to the plurality of namespace IDs; and writing the segregated incoming data to respective ones of a plurality of wordlines of a memory device.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example system for namespace data segregation;

FIG. 2 illustrates an example computing system of the system of FIG. 1 connected to a communication network;

FIG. 3 illustrates an example data storage system of the system of FIG. 1.

FIG. 4 illustrates an example non-volatile memory (NVM) media of the system of FIG. 1;

FIG. 5 illustrates an example namespace management component of the system of FIG. 1;

FIG. 6 illustrates an example memory device layout including a virtual block of the system of FIG. 1;

FIG. 7A illustrates an example triple-level cell (TLC) wordline of the system of FIG. 1;

FIG. 7B illustrates another example TLC wordline of the system of FIG. 1;

FIG. 8A illustrates example programming states of a TLC wordline of the system of FIG. 1;

FIG. 8B illustrates an example highest programming state of a TLC wordline of the system of FIG. 1;

FIG. 9 illustrates an example method for namespace data segregation performed by the system of FIG. 1;

FIG. 10A illustrates an example method for erasing data with namespace data segregation performed by the system of FIG. 1;

FIG. 10B illustrates another example method for erasing data with namespace data segregation performed by the system of FIG. 1; and

FIG. 11 illustrates an example method for valid data frame (VDF) count maintenance with namespace data segregation performed by the system of FIG. 1.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms "exemplary," "by example," and "for example," means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In various examples of the present disclosure, a data storage system may include a memory device. The memory device may store data. The data may include data of a plurality of data streams. The data storage system may be connected to a host system. In various examples, the data storage system may be connected to the host system by wired or wireless means. In various examples, the data storage system may be connected to more than one host system, such as in a multi-tenant environment, without limitation.

The data storage system may include a controller and the memory device. The controller may be operable to manage storage and retrieval of data to and from the memory device. The host system may send data to the data storage system for storage in the memory device. The host system may send a read request to the data storage system. The read request may indicate data to be retrieved from the memory device and sent back to the host system. The controller may process the read request and retrieve the data from the memory device.

In various examples, the memory device may be a solid state drive (SSD) including a plurality of non-volatile memory (NVM) media (e.g., NAND-based memory media) for data storage. In various examples, the NVM media may include chip enable (CE) ports which may also be referred to as targets. Examples may be used in single-level cell (SLC) systems, multiple-level cell (MLC) systems, triple-level cell (TLC) systems, quadruple-level cell (QLC) systems, and penta-level cell (PLC) systems, without limitation. Applications include high performance computing (HPC), data transfer for AI, and data center solutions (DCS).

The NVM media may respectively include a local controller and a plurality of die. In various examples, the NVM media may respectively include two (2), four (4), eight (8), sixteen (16), twenty four (24), thirty two (32), or more die, without limitation. Each die may correspond to a logical unit (LUN). Each LUN may include a plurality of planes. Each LUN may include, for example, four (4), six (6), eight (8), or more planes, without limitation. Each plane may include a cache register, a page register, and a plurality of physical memory blocks. When data is written to or retrieved from the NVM media, the data may be temporarily stored in one of the cache register and the page register. Each physical memory block may include a plurality of pages. The cache register and the page register may respectively have an equivalent data capacity of one page. Accordingly, data to be written to one page may be temporarily stored in the cache register while data to be written to another page may be temporarily stored in the page register. Data to be read from a first page may be retrieved and temporarily stored in one of the cache register and the page register while data read from a second page is stored in the other of the cache register and the page register. Accordingly, the cache register and page register enable double buffering of data to reduce data programming and read times. Each page may include a plurality of cells. Data bits may be written to the plurality of cells on a page-by-page basis. Data may be erased from the plurality of cells on a physical memory block basis.

The NVM media may additionally include a plurality of wordlines and a plurality of bit lines. Each wordline may correspond to physical locations of a set of pages. Each set of pages may span multiple planes. As used herein, a wordline may include a set of pages spanning a plurality of planes. Each bit line may correspond to physical locations of a string of cells. A physical address of a particular cell may correspond to an intersection of a particular wordline and a particular bit line. Data may be written to the particular cell by activating the particular wordline and the particular bit line. In various examples, each wordline may include at least one page from each plane of the NVM media.

In various examples, the cells may include single-level cells (SLCs), multi-level cells (MLCs), triple-level cells (TLCs), quadruple-level cells (QLCs), and/or penta-level cells (PLCs), without limitation. Accordingly, the wordlines may be SLC wordlines, MLC wordlines, QLC wordlines and/or PLC wordlines, without limitation. In an example, a TLC wordline may span four (4) planes. The four (4) planes may respectively include a lower page, a middle page, and an upper page of the wordline. The lower page, middle page, and upper page may correspond to TLCs. The TLC wordline may be activated to write data to each of the upper, middle, and lower pages of each of the four (4) planes. Accordingly, an SLC wordline may be associated with one (1) page from each plane, an MLC wordline may include two (2) from each plane, a TLC wordline may include three (3) pages from each plane, a QLC wordline may include four (4) pages from each plane, and a PLC wordline may include five (5) pages from each plane.

The controller may organize the physical blocks of the NVM media into a plurality of virtual blocks. A virtual block is a collection of physical blocks across all LUNs. In various examples, a virtual block may be formed to include one physical block from each plane of each LUN. The size of a virtual block may be (# Channels) x (# Targets per channel) x (# LUNs per target) x (# planes per LUN) x (one (1) block/LUN). In an example, a virtual block may span sixteen (16) channels, eight (8) targets per channel, two (2) LUNs per target, and two (2) planes per LUN, for a total of five hundred twelve (512) physical blocks. The example memory device may support a plurality of virtual blocks respectively including five hundred twelve (512) physical blocks. Additionally, the example virtual block may be further segmented into smaller virtual blocks. For example, the example memory device may support four (4) virtual blocks having a respective size of one hundred twenty-eight (128) physical blocks. In another example, the memory device may support eight (8) virtual blocks having respective sizes of sixty-four (64) blocks. It would be appreciated by one of ordinary skill in the art that a memory device may include more or fewer channels, targets, LUNs, and planes without departing from the scope of the present disclosure. The virtual blocks may be formed to include more or fewer physical blocks depending on the capacity of the memory device.

Each physical block may include a plurality of physical pages. A virtual block comprises multiple virtual pages. A virtual page is a collection of physical pages across all LUNs in a virtual block. A virtual page may be a redundant array of independent disks (RAID) stripe which contains one or two XOR parity pages. A RAID is a way of storing the same data in different places on multiple SSDs to protect data in the case of a drive failure. The number of virtual pages in a virtual block is equal to the number of physical pages in a single block. Similarly, a virtual word line (VWL) is a collection of physical WLs across each plane of each LUN. A flash transition layer (FTL) of the controller may manage the physical blocks in a virtual block unit. The FTL may manage a list of virtual blocks according to their states (i.e., free, open, used).

The controller may receive incoming data associated with respective namespaces. In various examples, incoming data may be received for or correspond to any number of namespaces, such as four (4), eight (8), twelve (12), sixteen (16), twenty-four (24), thirty-two (32), or sixty-four (64) namespaces, without limitation. Each namespace may be associated with different amounts of incoming data to be stored in the memory device. Each namespace may be associated with data having different formats. The different formats may be different logical block addressing (LBA) data formats. The different LBA data formats may have respective sizes of LBA data and metadata. In various examples, one or more of the namespaces may be associated with a zoned namespace (ZNS). Data for a ZNS may be written to multiple virtual blocks.

In various examples, the controller may identify incoming data associated with respective namespaces based on corresponding namespace identifiers (IDs) included in the incoming data. The controller may segregate the incoming data according to the namespace IDs. The controller may write the segregated incoming data to respective wordlines. In various examples, the respective wordlines may be organized into a virtual block. For example, a virtual block may include a set of the wordlines.

In various examples, incoming data for a given namespace may be written to multiple wordlines if there is enough data for the given namespace to do so. Accordingly, one wordline may only contain data for one namespace, and multiple wordlines can contain data for one namespace. In various examples, one or more of the namespaces may be a ZNS. The data for a ZNS may be written to corresponding virtual blocks.

In various examples, the controller may maintain a separate valid data frame (VDF) count for each namespace. The VDF count may be a number of VDFs for a given namespace. The controller may receive a namespace format command including a data erase request from the host to erase data for a particular namespace. The controller may issue a corresponding namespace format command to set the VDF count of the particular namespace to zero (0). Setting the VDF count to zero (0) may ensure fast format command processing compared to conventional operations.

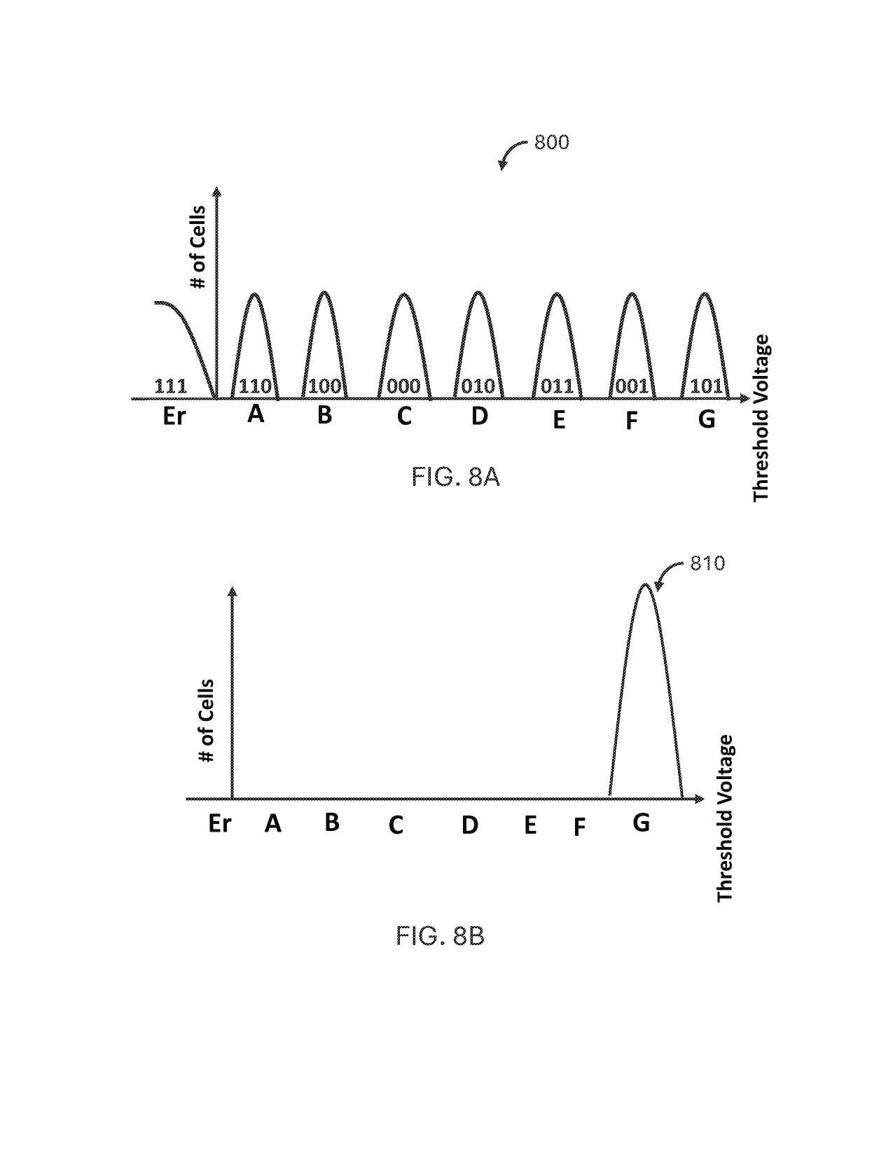

In various examples, the host system may issue a user data erase request in a secure erase setting (SES) as part of a namespace format command for a particular namespace. In response to receiving the user data erase request, the controller may issue a single state program command to erase or corrupt data associated with the particular wordline. The namespace format command including the user data erase request may be issued for a particular namespace. One or more wordlines associated with the particular namespace may be programmed to a same state by the single state program command. In various examples, the same state may be a highest state of a plurality of programming states. For example, the one or more wordlines may be TLC wordline(s), and the same state may be a G-state. The G-state may correspond to a highest threshold voltage of a memory cell (as shown in FIG. 8B) of a TLC wordline compared to other programming states (as shown in FIG. 8A). The controller may clear logical to physical (L2P) mapping table entries for the target namespace. Subsequent to clearing the L2P mapping table entries for the target namespace, the controller may issue a single state program command to program the wordline(s) associated with the particular namespace to the G-state.

In various examples, the controller may issue the sanitize command to the memory device. The sanitize command may be received from the host system. The sanitize command may be a single state program command to program all user data and system data blocks to the G-state to erase the entire memory device. Accordingly, latency associated with erasing all data from the memory device may be reduced compared to conventional erase operations.

In various examples, the controller may perform wear leveling and garbage collection (GC) operations. The wear leveling operations may include monitoring program/erase (P/E) cycles and/or error data of the virtual blocks. The monitored P/E cycles and error data may be utilized to select virtual blocks for data storage. For example, a virtual block having a lowest number of P/E cycles and/or a lowest number of errors may be selected to store new data from a particular namespace or set of namespaces. Accordingly, the controller can ensure that the virtual blocks wear in an even manner to improve a lifetime of the memory device. The GC operations may include identifying valid data and invalid data for a particular virtual block. The invalid data may be data that was deallocated, re-written, or formatted by the host system. The GC operations may include moving valid data from the particular virtual block to a second virtual block and erasing the invalid data. When a namespace format command is issued with a secure data erase request for a given namespace, the controller may selectively erase invalid data for the namespace in addition to erasing valid data for the given namespace. The invalid data may be stored in one or more free virtual blocks. The valid data may be stored in one or more open and/or used virtual blocks. A free virtual block may be a virtual block that does not contain any valid data and may be selected to be opened for storing data. An open virtual block may be a virtual block that is actively enabled to receive and store data. A used virtual block may be a virtual block that has data stored thereon. Erasing the invalid data may include programming all wordlines of the particular virtual block to a same state. The same state may be the G-state, for example, if the wordlines of the particular virtual block are TLC wordlines. In other examples, the same state may be a different state corresponding to a highest state of the wordlines of the particular virtual block.

The controller may maintain a table of virtual block information. The table may be utilized by the controller to track source virtual blocks and target virtual blocks associated with GC operations. Data stored in a source virtual block may be moved to a target virtual block as part of the GC operations. After the data is moved to the target virtual block, the source virtual block may be in a free state. Responsive to receiving the namespace format command including the secure data erase request for a particular namespace from the host system, the controller may program any free blocks containing instances of data corresponding to the namespace to a highest state of a plurality of programming states. In various examples, the wordlines of the source virtual block may be TLC wordlines and the highest state may be the G-state. The free state may indicate that the source virtual block does not contain any valid data. Programming the cells of a virtual block to the highest state of the plurality of programming states may ensure that all instances of data of the particular namespace contained within the virtual block are erased and may enable a fast, efficient, and secure manner of erasing user data compared to conventional erase operations.

In various examples, all virtual blocks associated with a ZNS may be similarly programmed to the highest state as part of user data erase operations. Accordingly, latency associated with erasing multiple virtual blocks may be reduced compared to conventional erase operations.

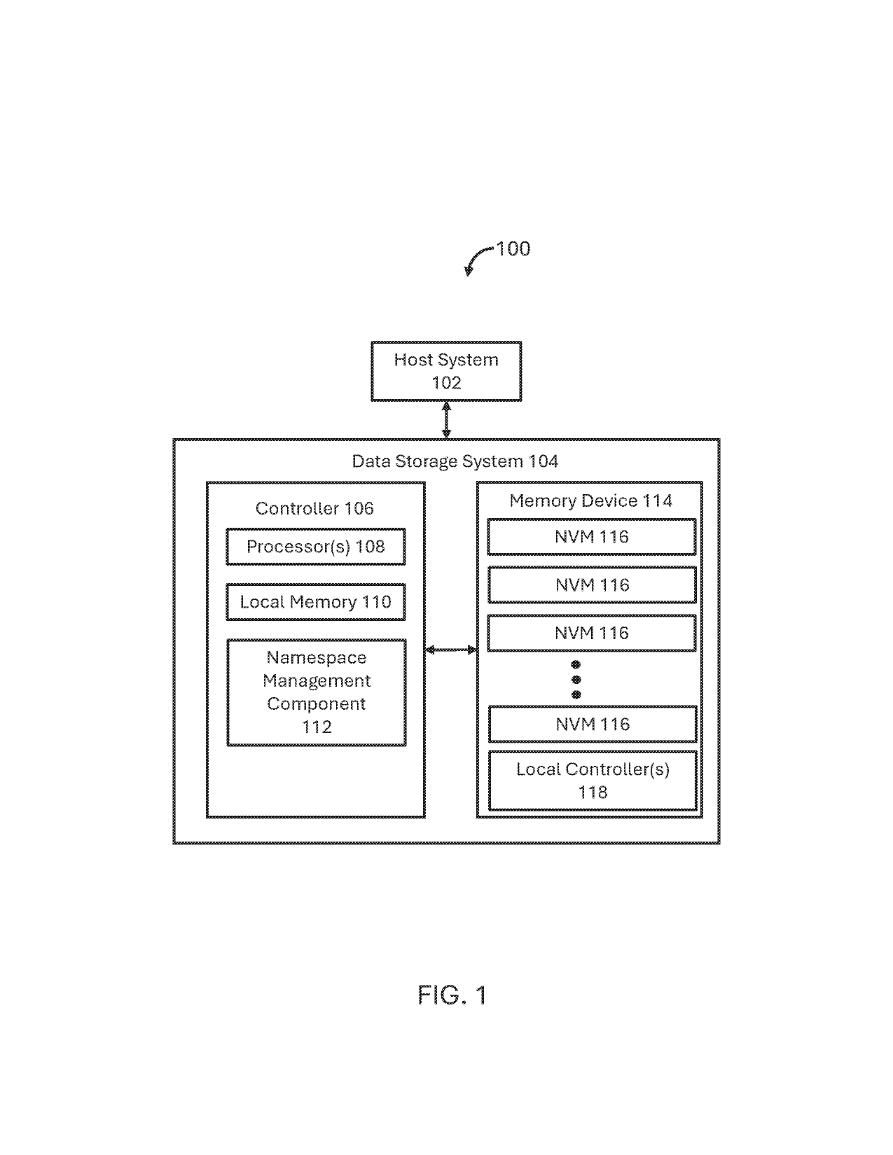

FIG. 1 illustrates an example system 100 including a host system 102 and a data storage system 104. The data storage system 104 may include a controller 106. The controller 106 may include a processor 108, a local memory 110, and a namespace management component 112. The data storage system 104 may also include a memory device 114. The memory device 114 may include a plurality of NVM media 116 and one or more local controller(s) 118.

In various examples, a read or write request may be received from the host system 102 via a peripheral component interconnect express (PCIe) interface that connects the data storage system 104 to servers or CPUs. PCIe is a standardized interface for motherboard components. The controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random access memory (SDRAM), without limitation. In various examples, the mWCCBs 113 may be contained within the local memory 110 or may be physically separate from the local memory 110, without limitation.

When a data request is received from the host system 102, the controller 106 references the L2P mapping table to determine the PBA within the NVM media 116 corresponding to a desired LBA. Once the PBA is determined, the controller 106 accesses the appropriate NVM media 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the memory device 114 may support a direct memory access (DMA) operation enabling data to be written from the host system 102 directly to the NVM media 116 and read from the NVM media 116 directly to the host system 102. Certain commands may be issued to the controller 106 or the local controller(s) 118 using the host command layer, or non-volatile memory express management interface (NVMe-MI).

The NVM media 116 may include a plurality of wordlines. The plurality of wordlines may be organized into a plurality of virtual blocks.

The namespace management component 112 may receive incoming data associated with respective namespaces. In various examples, incoming data may be received for or correspond to any number of namespaces, such as four (4), eight (8), twelve (12), sixteen (16), twenty-four (24), thirty-two (32), or sixty-four (64) namespaces, without limitation. Each namespace may be associated with different amounts of incoming data to be stored in the memory device. Each namespace may be associated with data having different formats. The different formats may be different LBA data formats. The different LBA data formats may have respective sizes of LBA data and metadata. In various examples, one or more of the namespaces may be associated with a ZNS. Data for a ZNS may be written to multiple virtual blocks.

In various examples, the namespace management component 112 may identify incoming data associated with respective namespaces based on corresponding namespace identifiers (IDs) included in the incoming data. The namespace management component 112 may segregate the incoming data according to the namespace IDs. The namespace management component 112 may write the segregated incoming data to respective wordlines.

In various examples, incoming data for a given namespace may be written to multiple wordlines if there is enough data for the given namespace to do so. Accordingly, one wordline may only contain data for one namespace, and multiple wordlines can contain data for one namespace. In various examples, one or more of the namespaces may be a ZNS. The data for a ZNS may be written to corresponding virtual blocks.

In various examples, the namespace management component 112 may maintain a separate valid data frame VDF count for each namespace for respective ones of the plurality of virtual blocks. Each VDF count may represent a number of VDFs for a given namespace for a given virtual block. Data for a corresponding namespace may be stored in more than one virtual block. For example, the namespace management component 112 may maintain a first VDF count for data of a first namespace stored in a first virtual block of the plurality of virtual blocks and a second VDF count for data of the first namespace stored in a second virtual block of the plurality of virtual blocks. Some namespaces of the plurality of namespaces may have data stored in only one virtual block. Other namespaces of the plurality of namespaces may have data stored in more than one virtual block of the plurality of virtual blocks. The namespace management component 112 may receive a namespace format command including a data erase request from the host system to erase data for a given namespace.

The namespace management component 112 may issue a namespace format command for the first namespace in response to receiving the namespace format command including the data erase request for the first namespace. The VDF count for the first namespace may be set to zero (0) for the first namespace for one or more of the respective ones of the plurality of virtual blocks. For example, the VDF count for the data of the first namespace may be set to zero (0) for a first virtual block of the plurality of virtual blocks and the VDF count for the data of the first namespace may be set to zero (0) for a second virtual block of the plurality of virtual blocks. Setting the VDF count to zero (0) may ensure fast format command processing compared to conventional operations.

In various examples, the host system 102 may issue a user data erase in a secure erase setting (SES) as part of a namespace format command. The user data erase may be issued for a particular namespace. The user data erase request may be received by the namespace management component 112. One or more wordlines associated with the particular namespace may be programmed to a same state. For example, the one or more wordlines may be TLC wordline(s), and the same state may be a G-state. The G-state may correspond to a highest threshold voltage of a memory cell (as shown in FIG. 8B) of a TLC wordline compared to other programming states (as shown in FIG. 8A). In other examples, the wordlines may be SLC, MLC wordlines, QLC wordlines, or PLC wordlines, and the highest state may correspond to a highest state of the SLC, MLC wordlines, QLC wordlines, or PLC wordlines, without limitation. The namespace management component 112 may clear logical to physical (L2P) mapping table entries for the target namespace. Subsequent to clearing the L2P mapping table entries for the target namespace, the namespace management component 112 may issue a single state program command to program the wordline(s) associated with the particular namespace to the highest state.

In various examples, the host system 102 may issue the sanitize command to the namespace management component 112. The sanitize command may be a single state program command to program all user data and system data blocks to the highest state to erase the entire memory device. The namespace management component 112 may receive the sanitize command from the host system 102. In response to receiving the sanitize command, the namespace management component 112 may issue the single state program command. Accordingly, latency associated with erasing all data from the memory device may be reduced compared to conventional erase operations.

In various examples, the namespace management component 112 may perform wear leveling and GC operations. The wear leveling operations may include monitoring P/E cycles and/or error data of the virtual blocks. The monitored P/E cycles and error data may be utilized to select virtual blocks for data storage. For example, a virtual block having a lowest number of P/E cycles and/or a lowest number of errors may be selected to store new data from a particular namespace or set of namespaces. Accordingly, the namespace management component 112 can ensure that the virtual blocks wear in an even manner to improve a lifetime of the memory device.

The GC operations may include identifying valid data and invalid data for a particular virtual block. The invalid data may correspond to data that has been moved to a new virtual block or deallocated by the host system 102. The GC operations may include moving valid data from the particular virtual block to a second virtual block. When a namespace format command for a given namespace includes a user data erase request, the namespace management component may erase the invalid data. Erasing the invalid data by the namespace management component 112 may include programming all wordlines of the particular virtual block to a same state. The same state may be the highest state. The namespace management component 112 may maintain a table of virtual block information. The table may be utilized by the namespace management component 112 to track source virtual blocks and target virtual blocks associated with GC operations. Data stored in a source virtual block may be moved to a target virtual block as part of the GC operations. After the data is moved to the target virtual block, the source virtual block may be in a free state. The invalid data in the source virtual block may be programmed to the highest state when the namespace format command includes the user data erase request. The free state may indicate that the source virtual block does not contain any valid data. Programming the cells of a virtual block to the highest state may ensure that all instances of data contained within the virtual block are erased and may enable a fast, efficient, and secure manner of erasing user data compared to conventional erase operations.

In various examples, the namespace management component 112 may similarly program all virtual blocks associated with a ZNS to the highest state as part of user data erase operations. Accordingly, latency associated with erasing multiple virtual blocks may be reduced compared to conventional erase operations.

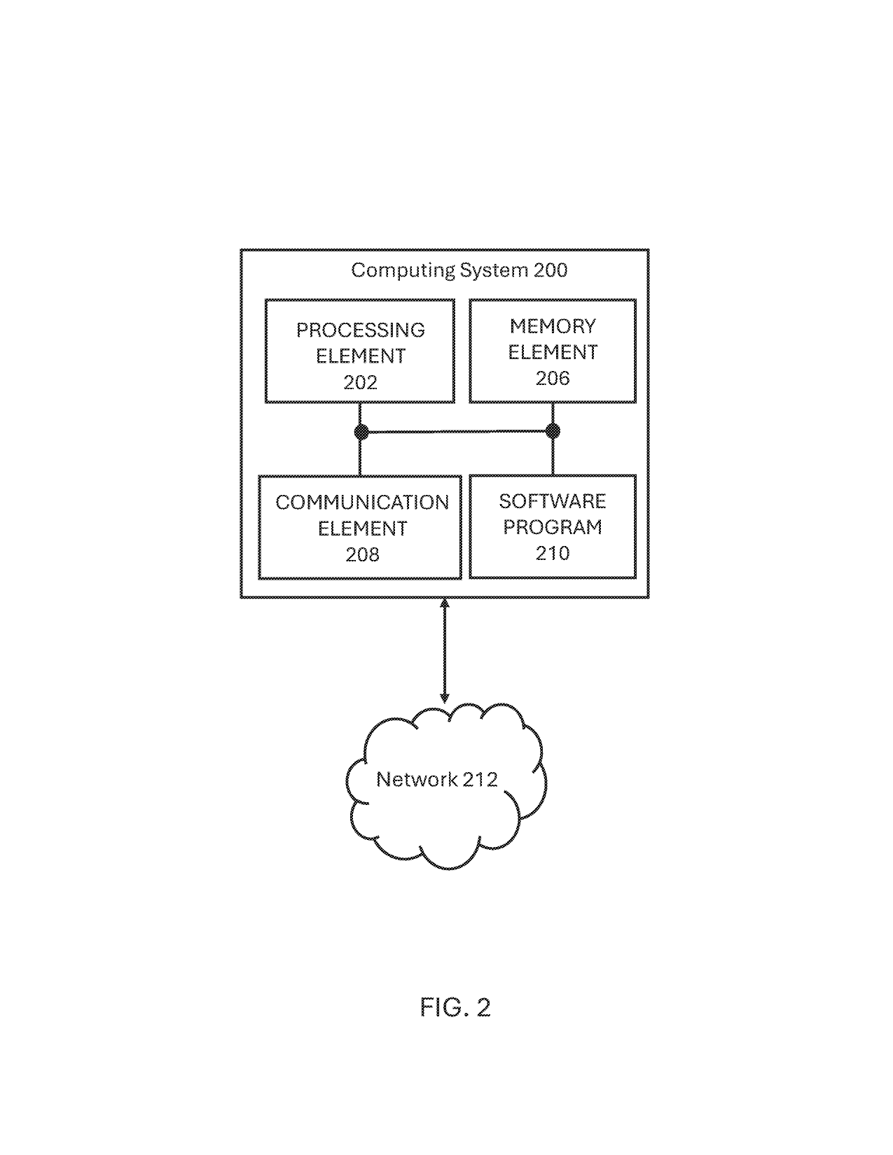

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1) and/or a data storage system (e.g., the data storage system 104 of FIG. 1), without limitation.

The software program 210 may be configured with instructions for performing and/or enabling performance of at least some of the steps set forth herein. In an embodiment, the software program 210 comprises instructions stored on computer-readable media of memory element 206. In various examples, the software program 210 may include instructions for performing operations of the namespace management component 112 discussed with reference to FIG. 1.

The communication network 212 generally allows communication between the computing system 200 and another computing device, such as between a remote host system (e.g., the host system 102), a local host system, and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain embodiments, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some embodiments, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In an embodiment, the memory element 206 respectively store the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the memory device 114 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may respectively execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

Through hardware, software, firmware, or various combinations thereof, the processing element 202 may – alone or in combination with other processing elements – be configured to perform the operations of embodiments of the present disclosure. The embodiments described herein in connection with the attached drawing figures are intended to describe aspects of the disclosure in sufficient detail to enable those skilled in the art to practice the disclosure. Other embodiments can be utilized and changes can be made without departing from the scope of the present disclosure. The system may include additional, less, or alternate functionality and/or device(s), including those discussed elsewhere herein. The above detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

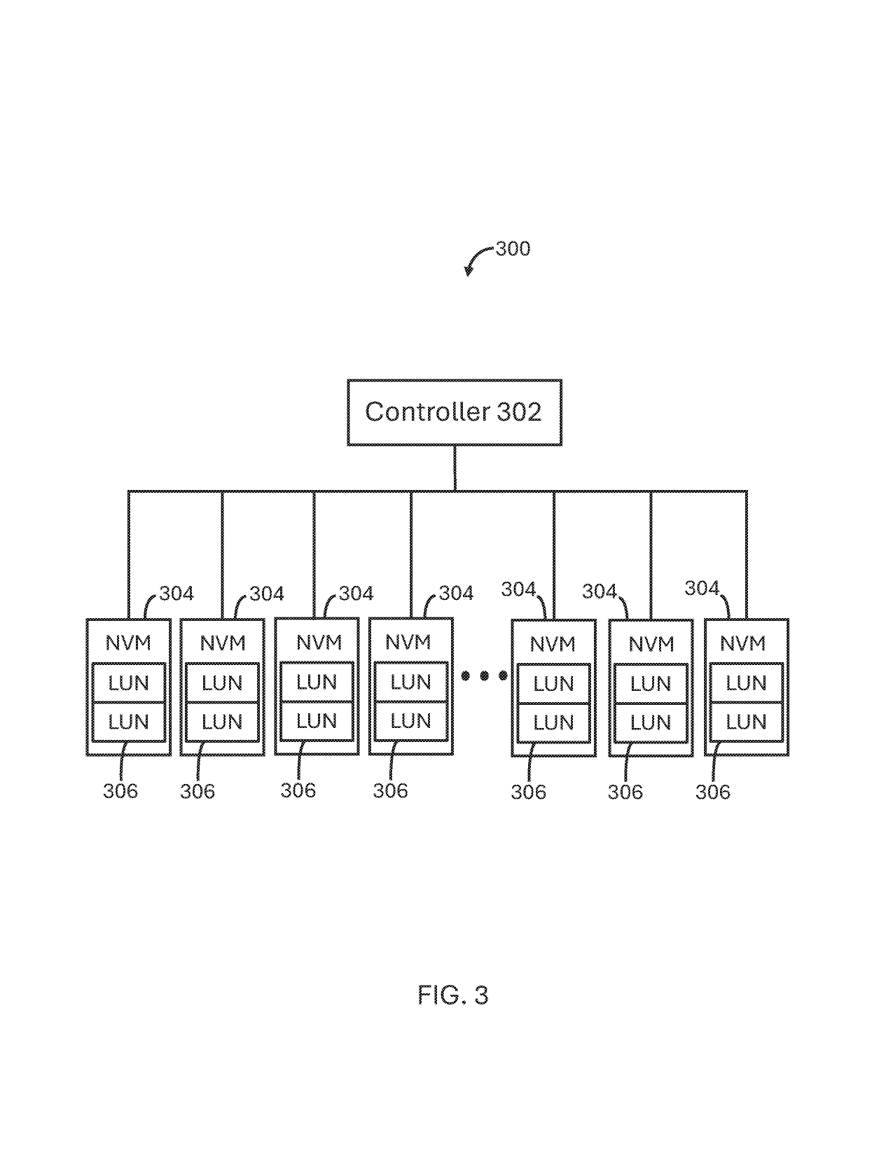

FIG. 3 illustrates an example data storage system 300 including a controller 302 and a plurality of NVM media 304. In various examples, the data storage system 300 may correspond to the data storage system 104 of FIG. 1, the controller 302 may correspond to the controller 106 of FIG. 1, and the NVM media 304 may correspond to the NVM media 116 of FIG. 1, without limitation. In various examples, the NVM media 304 may each include two LUNs 306. It would be appreciated by one of ordinary skill in the art that each NVM 304 may include more than two LUNs, without limitation. Each LUN 306 may correspond to a respective die of the NVM media 304. In various examples, the controller 302 may write incoming data to more than one NVM media 304 in parallel. The NVM media 304 may write incoming data to more than one LUN 306 in parallel.

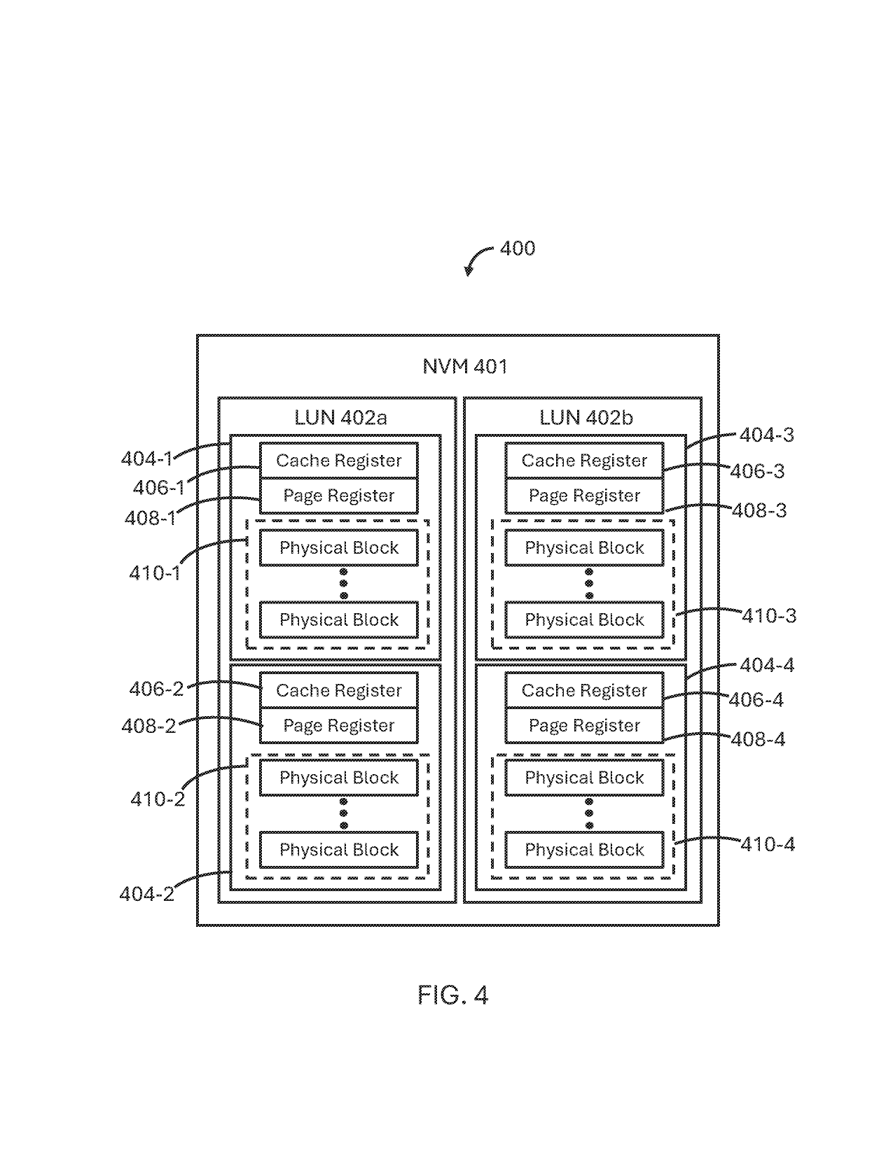

FIG. 4 illustrates an example NVM media 400. The NVM 400 may correspond to the NVM media 116 of FIG. 1 and/or the NVM media 304 of FIG. 3, without limitation. The NVM media 400 may include a LUN 402a and a LUN 402b. The LUN 402a may include a plane 404-1 and a plane 404-2. The plane 404-1 may include a cache register 406-1, a page register 408-1, and physical blocks 410-1. The plane 404-2 may include a cache register 406-2, a page register 408-2, and physical blocks 410-2. The LUN 402b may include a plane 404-3 and a plane 404-4. The plane 404-3 may include a cache register 406-3, a page register 408-3, and physical blocks 410-3. The plane 404-4 may include a cache register 406-4, a page register 408-4, and physical blocks 410-4. It would be appreciated by one of ordinary skill in the art that the NVM media 400 may include more than two (2) die and each die may include more than two (2) planes. In various examples, the NVM media 400 may include two (2), four (4), eight (8), sixteen (16), twenty four (24), thirty two (32), or more die, without limitation. Each die may include, for example, four (4), six (6), eight (8), or more planes, without limitation.

When data is written to or retrieved from the LUN 402a or the LUN 402b, the data may be temporarily stored in one of the cache registers 406-1, 406-2, 406-3, 406-4 and/or the page registers 408-1, 408-2, 408-3, 408-4. The cache registers 406-1, 406-2, 406-3, 406-4 and the page registers 408-1, 408-2, 408-3, 408-4 may respectively have an equivalent data capacity of one page. Accordingly, data to be written to one page of one of the physical blocks 410-1 may be temporarily stored in the cache register 406-1 while data to be written to another page of one of the physical blocks 410-1 may be temporarily stored in the page register 408-1. Data being read from a first page of one of the physical blocks 410-1 may be retrieved and temporarily stored in the page register 408-1 while data to be read from a second page of one of the physical blocks 410-1 may be stored in the cache register 406-1. Accordingly, the cache register and page register enable double buffering of data to reduce data programming and read times. Each page may include a plurality of cells. Data bits may be written to the plurality of cells on a page-by-page basis. Data may be erased from the plurality of cells on a physical block basis.

In various examples, one or more virtual wordlines (VWLs) and/or virtual blocks (VBs) may be formed across the planes 404-1, 404-2, 404-3, 404-4. In an example, a VWL may include one (1) wordline from each plane 404-1, 404-2, 404-3, 404-4. A VB may include one (1) physical block 410-1 from the plane 404-1, one (1) physical block 410-2 from the plane 404-2, one (1) physical block 410-3 from the plane 404-3, and one (1) physical block 410-4 from the plane 404-4. The wordlines or physical blocks that make up a VWL or VB may or may not be in a same location of each plane 404-1, 404-2, 404-3, 404-4.

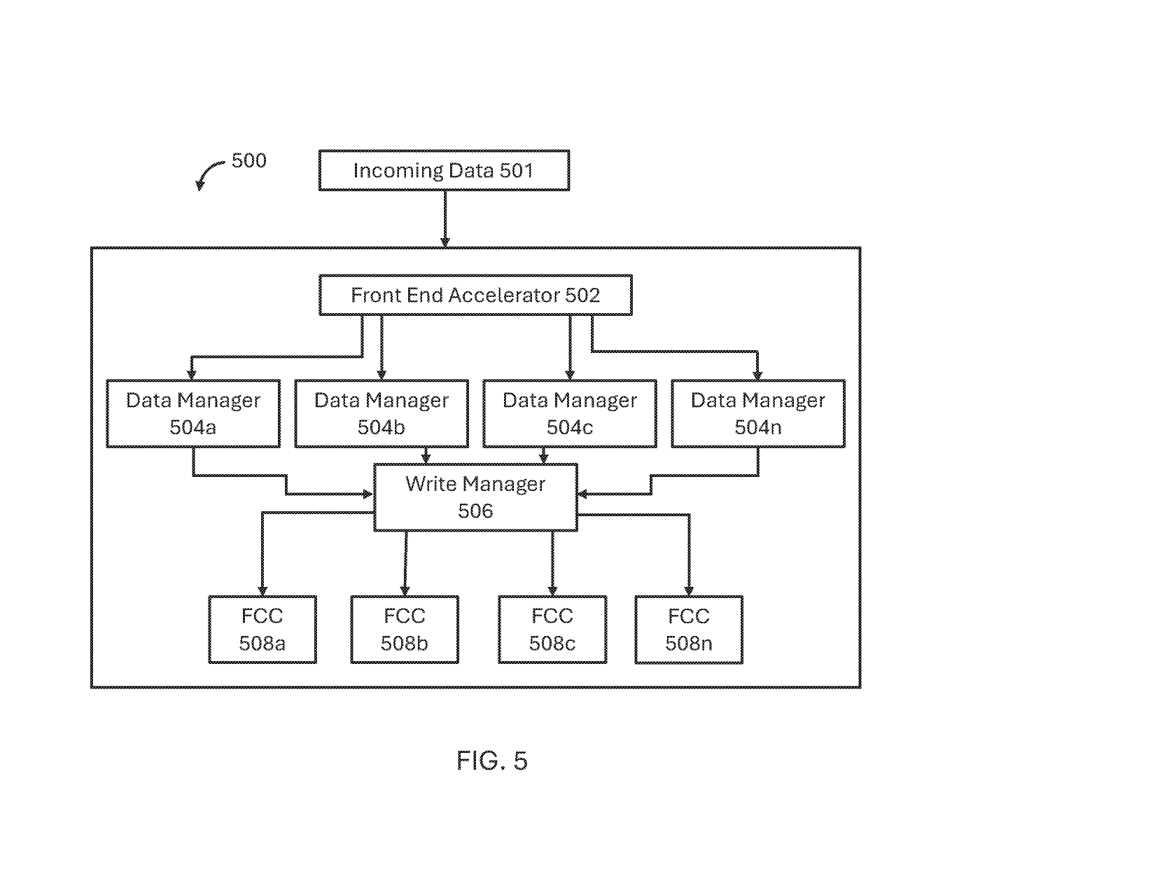

FIG. 5 illustrates a namespace management component 500 receiving incoming data 501. The namespace management component 500 may correspond to the namespace management component 112 of FIG. 1, without limitation. The namespace management component 500 may include a front end accelerator 502, data managers 504a, 504b, 504c, … , 504n, a write manager 506, and flash channel controllers (FCCs) 508a, 508b, 508c, … , 508n. The namespace management component 500 may be part of a data storage system (e.g., the data storage system 104 of FIG. 1) including a memory device (e.g., the memory device 114 of FIG. 1)

In various examples, the incoming data 501 may include data for a plurality of namespaces. Each namespace may be associated with data having different formats. The different formats may be different LBA data formats. The different LBA data formats may have respective sizes of LBA data and metadata. In various examples, one or more of the namespaces may be associated with a ZNS.

The front end accelerator 502 may receive the incoming data 501. The incoming data 501 may be received from a host system (e.g., the host system 102 of FIG. 1). The front end accelerator 502 may identify namespace identifiers (IDs) corresponding to the plurality of namespaces associated with the incoming data 501. The front end accelerator 502 may segregate the incoming data according to the namespace IDs. The front end accelerator 502 may send respective sets of the segregated data to the data managers 504a, 504b, 504c, … , 504n, such that each of the data managers 504a, 504b, 504c, … , 504n, receives a portion of the incoming data 501 associated with one of the namespaces. The data managers 504a, 504b, 504c, … , 504n, may accumulate data for corresponding namespaces until an amount of the data for the corresponding namespaces is sufficient to occupy respective wordlines. For example, the data manager 504a may receive a first portion of the incoming data 501 corresponding to a first namespace of the plurality of namespaces. The first portion of the incoming data 501 may not be sufficient to occupy a first wordline. The data manager 504a may subsequently receive a second portion of the incoming data 501 corresponding to the first namespace. The first portion and the second portion may be sufficient to occupy the first wordline. The data manager 504a consequently may pass the first and the second portion to the write manager 506. Similarly, the second data manager 504b may receive a third portion of the incoming data 501 corresponding to a second namespace. The third portion may be sufficient to occupy a second wordline. The second data manager 504b consequently may pass the third portion to the write manager 506.

The write manager 506 may distribute sets of the incoming data 501 to corresponding ones of the FCCs 508a, 508b, 508c, … , 508n. Each set of the incoming data 501 may be associated with a corresponding namespace. The write manager 506 may distribute the sets of the incoming data in a round robin fashion. Each of the FCCs 508a, 508b, 508c, … , 508n may correspond to a respective channel of the memory device. The FCCs 508a, 508b, 508c, … , 508n may write the sets of the incoming data 501 to corresponding wordlines in the open virtual block.

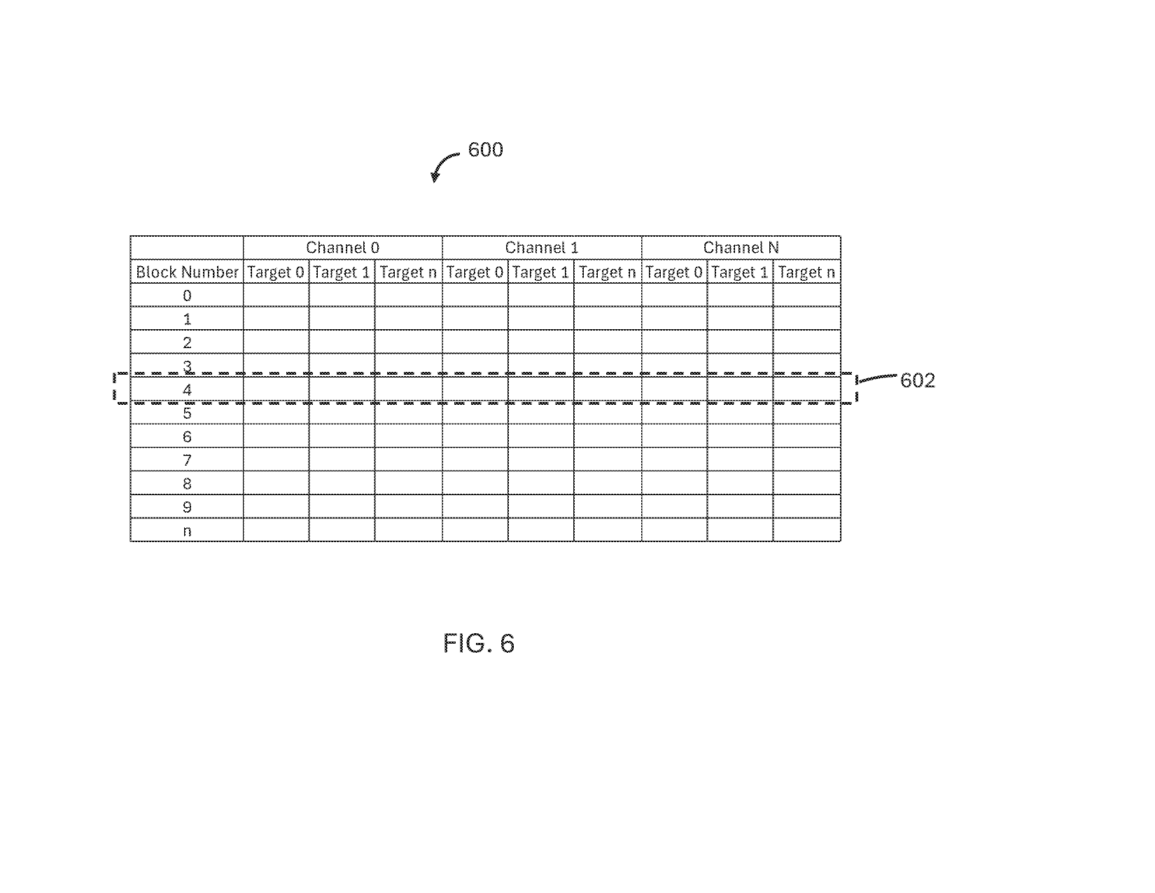

FIG. 6 illustrates an example memory device layout 600 including a virtual block 602. The memory device layout 600 may correspond to a memory device, such as the memory device 114 of FIG. 1. The memory device may include a plurality of NVM media, such as the NVM media 116 of FIG. 1. The NVM media may be referred to as targets. The memory device may include a plurality of channels. Each channel may include a plurality of targets. Each target may include a plurality of LUNs. Each LUN may include a plurality of planes. Each plane may include a plurality of physical blocks. For simplicity, the memory device layout 600 is shown as having a number n blocks per target. Each of the n blocks may correspond to a set of physical blocks. Each set of physical blocks may include one physical block from each plane of each LUN of a given target. The virtual block 602 may correspond to a certain physical block of each target, such as a fourth physical block, as shown. Accordingly, the virtual block 602 may include physical blocks from identical locations of each target. It would be appreciated by one of ordinary skill in the art that a virtual block may include physical blocks from different locations of each target without departing from the spirit of the present disclosure.

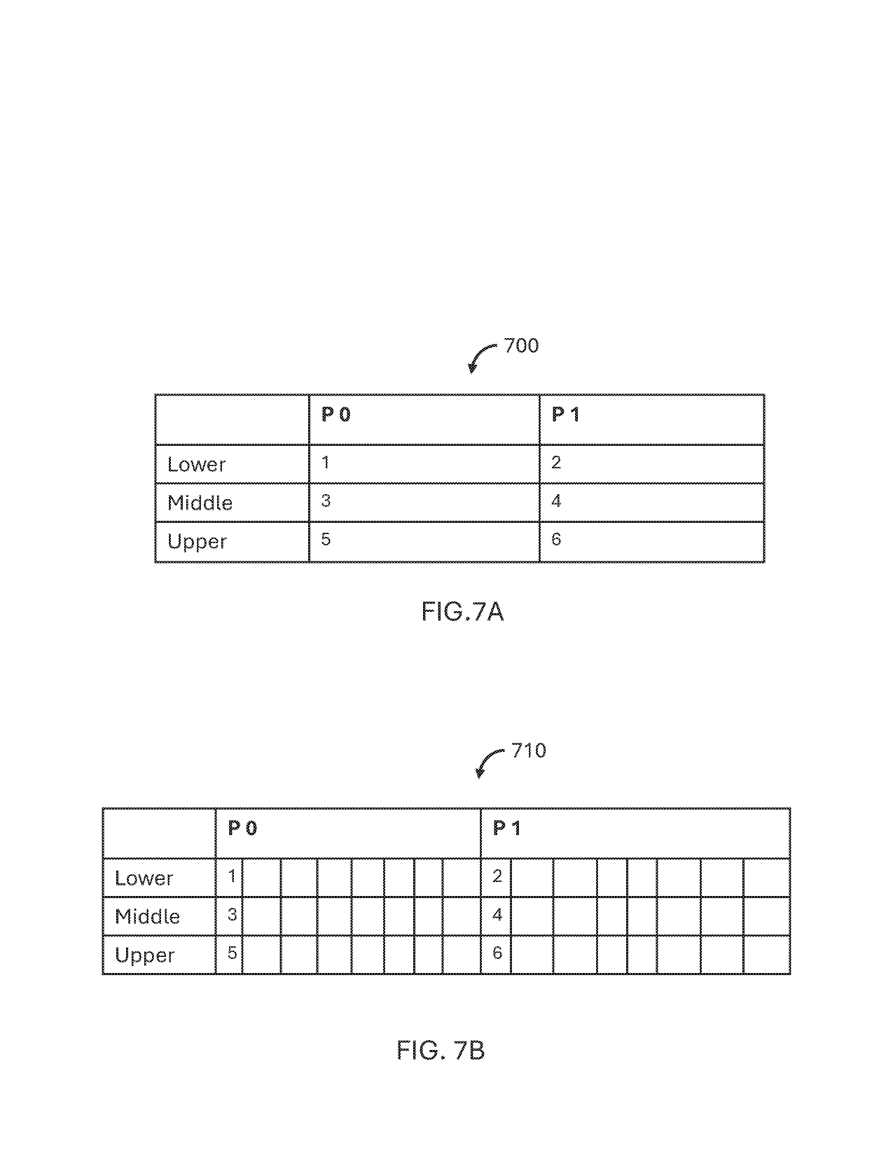

FIG. 7A illustrates a TLC wordline 700 spanning two (2) planes P0 and P1. The TLC wordline 700 may include three (3) pages from each of the planes P0 and P1. The TLC wordline 700 may include data for a namespace. The data may include respective error code correction (ECC) data chunks having a corresponding LBA format. One or more ECC chunks may be stored in each of the pages. Each ECC chunk may contain data and metadata of one (1) LBA, as dictated by the LBA format.

FIG. 7B illustrates a TLC wordline 710 spanning two (2) planes P0 and P1. The TLC wordline 700 may include three (3) pages from each of the planes P0 and P1. The TLC wordline 710 may include data for a namespace. The data may include respective error code correction (ECC) data chunks having a corresponding LBA format. One or more ECC chunks may be stored in each of the pages. Each ECC chunk may contain data and metadata of eight (8) LBAs, as dictated by the LBA format.

FIG. 8A illustrates example programming states 800 of a TLC wordline, such as the wordline 700 of FIG. 7A or the wordline 710 of FIG. 7B, of a memory device, such as the memory device 114 of FIG. 1, without limitation. The TLC wordline may include a plurality of cells. Each of the plurality of cells may store three (3) data bits. The cells may be in one of eight (8) different programming states according to values of each of the three (3) data bits. A lowest state of the programming states may correspond to an erased state. The erased state may be associated with a lowest threshold voltage of the TLC wordline. The data bit values corresponding to the erased state may be 111. A highest state of the programming states may correspond to a G-state. The G-state may correspond to a highest threshold voltage of the TLC wordline. The remaining states may correspond to A, B, C, D, E, and F-states and may be associated with threshold voltages between the erased state and the G-state. In various examples, data may be corrupted from the TLC by programming the TLC to the G-state. In various examples, the memory device may include wordlines other than TLC wordlines, such as SLC, MLC, DLC, and/or PLC wordlines. The SLC, MLC, DLC, and/or PLC wordlines may be associated with corresponding programming states, including respective highest and lowest states. The SLC, MLC, DLC, and/or PLC wordlines may be programmed to the respective highest states to securely erase or corrupt data in the corresponding wordline.

FIG. 8B illustrates an example highest programming state 810 of a TLC wordline, such as the wordline 700 of FIG. 7A or the wordline 710 of FIG. 7B, of a memory device, such as the memory device 114 of FIG. 1, without limitation. When a single state program command is issued, all cells of the TLC wordline may be pushed to the highest state 810. Accordingly, data may be securely, efficiently, and quickly erased compared to conventional erase operations.

The highest state 810 may be a G-state. The G-state 810 may be a highest programming state of a TLC wordline. In various examples, the memory device may include wordlines other than TLC wordlines, such as SLC, MLC, DLC, and/or PLC wordlines. The SLC, MLC, DLC, and/or PLC wordlines may be associated with corresponding programming states, including respective highest and lowest states. The SLC, MLC, DLC, and/or PLC wordlines may be programmed to the respective highest states to securely erase or corrupt data in the corresponding wordline.

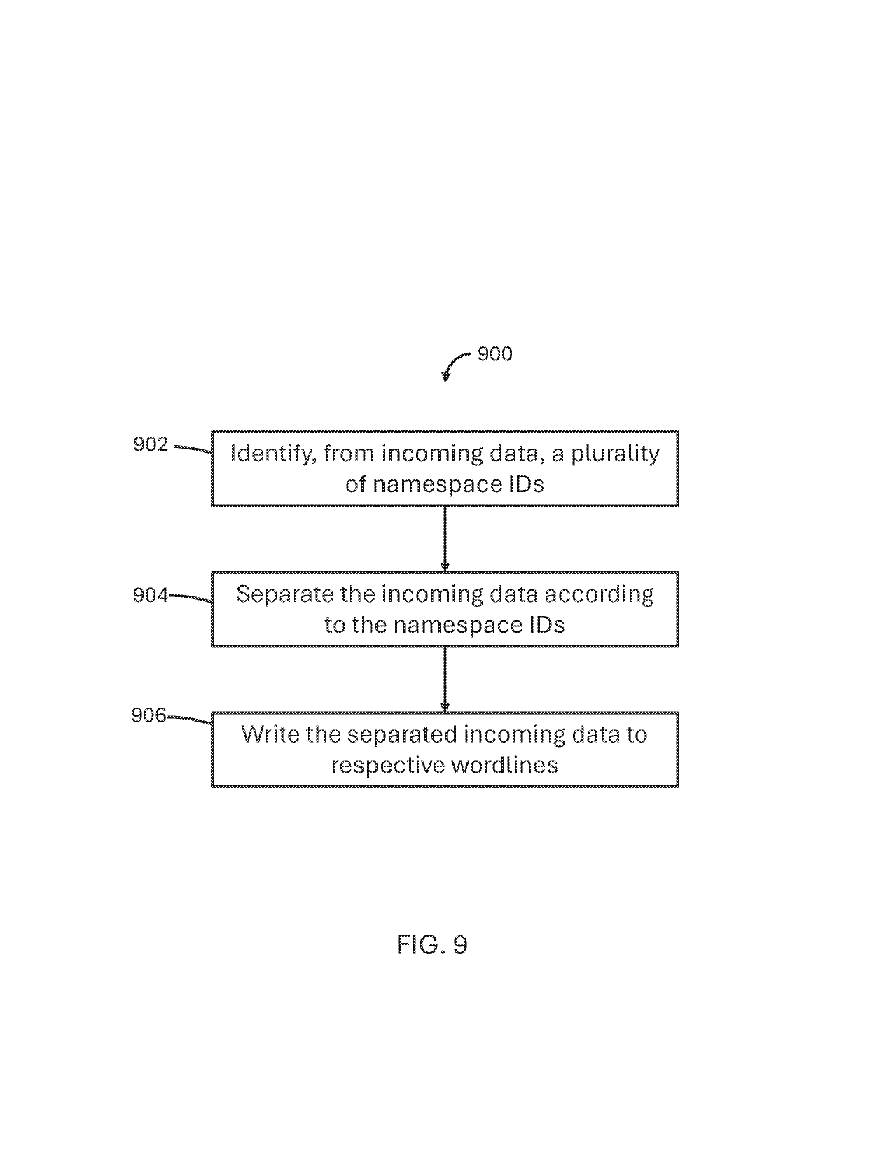

FIG. 9 illustrates an example method 900 for namespace data segregation. The method may be performed by a controller (e.g., the controller 106 and/or controller(s) 118 of FIG. 1) of a memory storage system (e.g., the data storage system 104 of FIG. 1). The controller may manage storage and retrieval of data to and from a memory device (e.g., the memory device 114 of FIG. 1). The controller may receive read and write requests from a host system (e.g., the host system 102 of FIG. 1). Upon receiving a write request, the controller may facilitate writing data received from the host system to the memory device. Upon receiving a read request, the controller may facilitate reading of data from the memory device and communication of the data to the host system.

The memory device may include a plurality of NVM media (e.g., the NVM media 116 of FIG. 1). The NVM media may each include a plurality of LUNs (e.g., the LUNs 306 of FIG. 3). Each LUN may include a respective set of planes (e.g., the planes 404-1, 404-2, 404-3, 404-4 of FIG. 4). The respective sets of planes may each include a plurality of physical blocks (e.g., the physical blocks 410-1, 410-2, 410-3, 410-4 of FIG. 4.)

The memory device may include a plurality of wordlines. The plurality of wordlines may be organized into a first virtual block. The first virtual block may include one (1) physical block from each plane of each LUN of each NVM media.

The controller may receive incoming data associated with respective namespaces. In various examples, incoming data may be received for or correspond to any number of namespaces, such as four (4), eight (8), twelve (12), sixteen (16), twenty-four (24), thirty-two (32), or sixty-four (64) namespaces, without limitation.

At operation 902, a plurality of namespace identifiers (IDs) may be identified from the incoming data. The namespace IDs may correspond to a plurality of namespaces.

At operation 904, the incoming data may be segregated according to the plurality of namespace IDs. The segregation may be logical and/or physical, may comprise or include operations 902 and 906 (i.e., where the segregation comprises identifying respective namespace IDs and accordingly routing the data to different ones of a plurality of wordlines) and/or may comprise or include additional operations whereby the respective portions of the incoming data having different IDs are at least temporarily stored separately or distinctly in memory in preparation for operation 906, without departing from the spirit of the present disclosure.

At operation 906, the segregated incoming data may be written to respective ones of the plurality of wordlines. In various examples, incoming data for a given namespace may be written to multiple wordlines if there is enough data for the given namespace to do so. Accordingly, one wordline may only contain data for one namespace, and multiple wordlines can contain data for one namespace. In various examples, one or more of the namespaces may be a ZNS. The data for a ZNS may be written to corresponding virtual blocks.

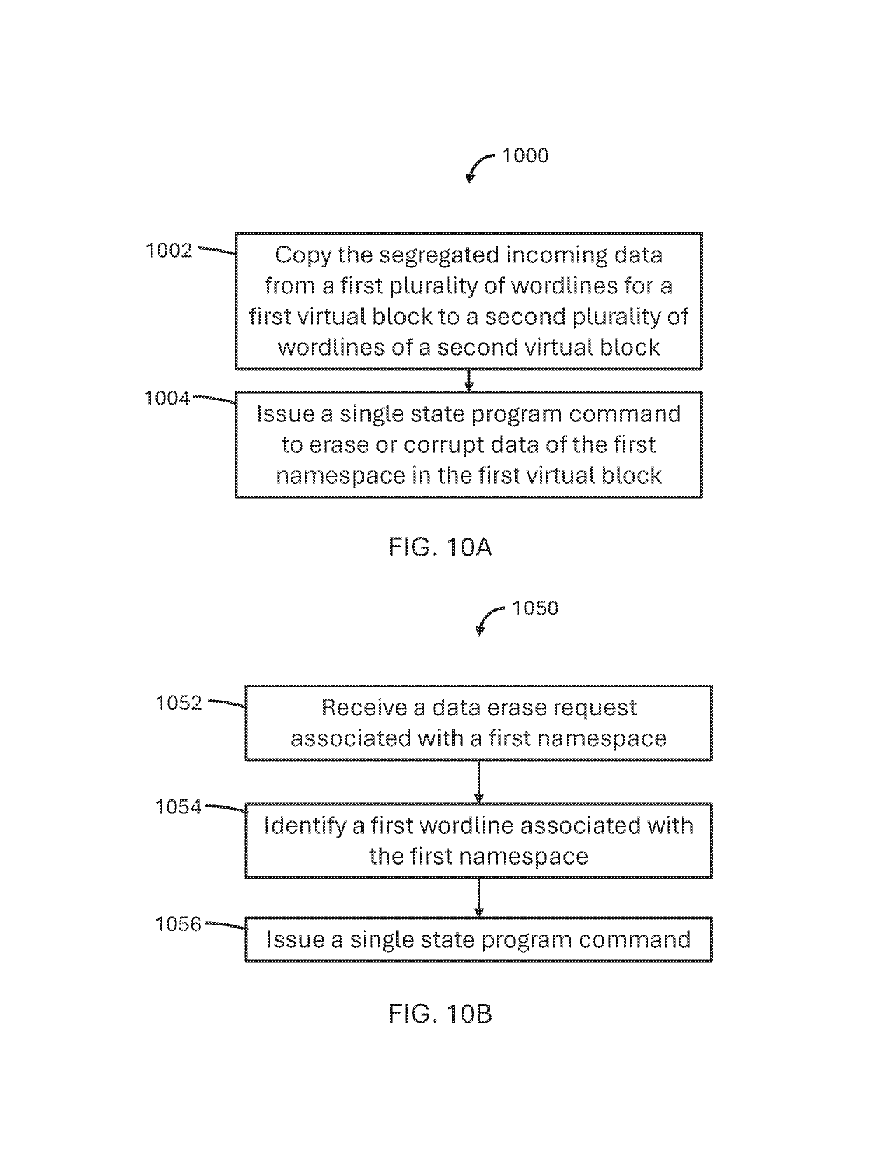

FIG. 10A illustrates an example method 1000 for erasing data with namespace data segregation. In various examples, the method 1000 may be performed in coordination with the method 900 of FIG. 9, such as subsequently to the operation 906 of the method 900. The method may be performed by a controller (e.g., the controller 106 and/or controller(s) 118 of FIG. 1) of a memory storage system (e.g., the data storage system 104 of FIG. 1). The controller may manage storage and retrieval of data to and from a memory device (e.g., the memory device 114 of FIG. 1). The controller may receive read and write requests from a host system (e.g., the host system 102 of FIG. 1). Upon receiving a write request, the controller may facilitate writing data received from the host system to the memory device. Upon receiving a read request, the controller may facilitate reading of data from the memory device and communication of the data to the host system.

The memory device may include a plurality of wordlines. The plurality of wordlines may be organized into a virtual block. Each of the wordlines may store data associated with a corresponding namespace. The data may correspond to the incoming data described with respect to the operations of the method 900.

In various examples, the controller may perform wear leveling and GC operations. The wear leveling operations may include monitoring P/E cycles and/or error data of the virtual blocks. The monitored P/E cycles and error data may be utilized to select virtual blocks for data storage. For example, a virtual block having a lowest number of P/E cycles and/or a lowest number of errors (or an optimal weighted summation of these, e.g., according to an objective function) may be selected to store new data from a particular namespace or set of namespaces. Accordingly, the controller can ensure that the virtual blocks wear in an even manner to improve a lifetime of the memory device. The GC operations may include identifying valid data and invalid data for a particular virtual block. The invalid data may be data that was erased. The GC operations may include moving valid data from the particular virtual block to a second virtual block.

At operation 1002, data stored in the virtual block may be copied to a second plurality of wordlines organized into a second virtual block as part of the wear leveling or GC operations.

At operation 1004, a single state program command may be issued to erase any remaining data of a given namespace stored in the virtual block. The single state program command may be issued in response to receiving a namespace format command including a user data erase request for the given namespace. The virtual block may be a free virtual block containing older instances of data for the given namespace. The older instances of the data may be invalid data. In various examples, older instances of the user data may be present in more than one free virtual block. The single state program command may be issued to any free virtual blocks containing the older instances of the data to securely erase or corrupt the data for the given namespace. Erasing or corrupting the invalid data may include programming all wordlines of the particular virtual block to a same state. In various examples, the same state may be a highest state of a plurality of programming states. For example, the one or more wordlines may be TLC wordline(s), and the same state may be a G-state. The G-state may correspond to a highest threshold voltage of a memory cell (as shown in FIG. 8B) of a TLC wordline compared to other programming states (as shown in FIG. 8A).

The controller may maintain a table of virtual block information. The table may be utilized by the controller to track source virtual blocks and target virtual blocks associated with GC operations. Data stored in a source virtual block may be moved to a target virtual block as part of the GC operations. After the data is moved to the target virtual block, the source virtual block may be in a free state and may be programmed to the highest state. The free state may indicate that the source virtual block does not contain any valid data. Programming the cells of a virtual block to the highest state in response to receiving a namespace format command including a user data erase request for a given namespace may ensure that all instances of data for the given namespace contained within the virtual block are erased and may enable a fast, efficient, and secure manner of erasing user data compared to conventional erase operations.

FIG. 10B illustrates an example method 1050 for erasing data with namespace data segregation. In various examples, the method 1050 may be performed in coordination with the method 900 of FIG. 9, such as subsequently to the operation 906 of the method 900, and/or in coordination with the method 1000 of FIG. 10A, such as by being applied prior to operation 1004 and/or to different virtual blocks and/or at different times than the method 1000. The method may be performed by a controller (e.g., the controller 106 and/or controller(s) 118 of FIG. 1) of a memory storage system (e.g., the data storage system 104 of FIG. 1). The controller may manage storage and retrieval of data to and from a memory device (e.g., the memory device 114 of FIG. 1). The controller may receive read and write requests from a host system (e.g., the host system 102 of FIG. 1). Upon receiving a write request, the controller may facilitate writing data received from the host system to the memory device. Upon receiving a read request, the controller may facilitate reading of data from the memory device and communication of the data to the host system.

The memory device may include a plurality of wordlines. The plurality of wordlines may be organized into a virtual block. Each of the wordlines may store data associated with a corresponding namespace. The data may correspond to the incoming data described with respect to the operations of the method 900.

At operation 1052, a data erase request associated with a first namespace may be received. The data erase request may be received from the host system.

At operation 1054, a first wordline of the plurality of wordlines associated with the first namespace may be identified. In some examples, the first wordline may include more than one wordline. In other examples, such as in the example of a ZNS, one or more virtual blocks associated with the namespace may be identified.

At operation 1056, a single state program command may be issued to erase any data stored in the identified first wordline. Erasing the data may include programming the identified first wordline to a same state. In various examples, the same state may be a highest state of a plurality of programming states. For example, the one or more wordlines may be TLC wordline(s), and the same state may be a G-state. The G-state may correspond to a highest threshold voltage of a memory cell (as shown in FIG. 8B) of a TLC wordline compared to other programming states (as shown in FIG. 8A). The controller may clear logical to physical (L2P) mapping table entries for the target namespace. Subsequent to clearing the L2P mapping table entries for the target namespace, the controller may issue the single state program command to program the first wordline to the highest state. Programming the cells of the first wordline to the highest state may ensure that all instances of data contained within the first wordline are erased and may enable a fast, efficient, and secure manner of erasing user data compared to conventional erase operations.

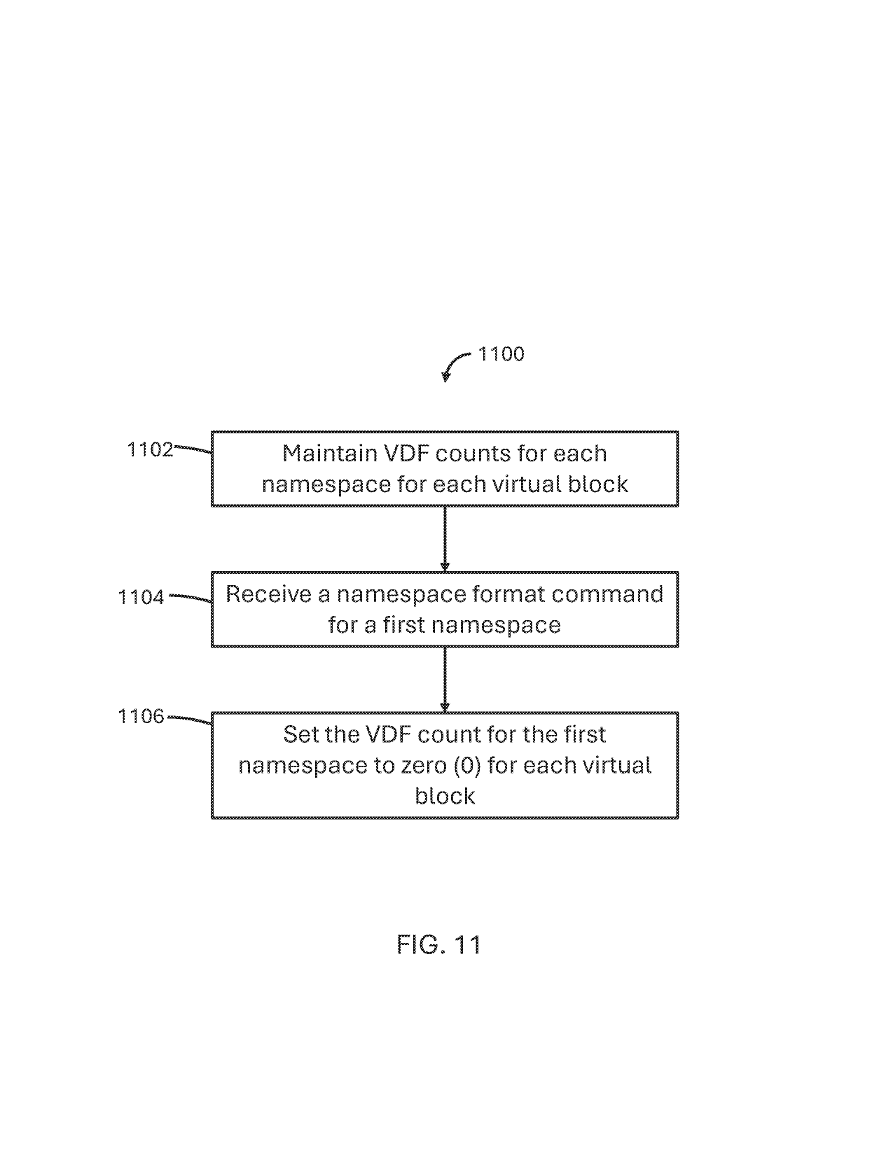

FIG. 11 illustrates an example method 1100 for VDF count maintenance with namespace data segregation. In various examples, the method 1100 may be performed in coordination with the method 900 of FIG. 9, such as subsequently to the operation 906 of the method 900, and/or in coordination with the method 1000 of FIG. 10A or the method 1050 of FIG. 10B, such as by being applied prior to operation 1004 and/or subsequent to the operation 1056 and/or to different virtual blocks and/or at different times than the method 1000 and/or the method 1050. The method may be performed by a controller (e.g., the controller 106 and/or controller(s) 118 of FIG. 1) of a memory storage system (e.g., the data storage system 104 of FIG. 1). The controller may manage storage and retrieval of data to and from a memory device (e.g., the memory device 114 of FIG. 1). The controller may receive read and write requests from a host system (e.g., the host system 102 of FIG. 1). Upon receiving a write request, the controller may facilitate writing data received from the host system to the memory device. Upon receiving a read request, the controller may facilitate reading of data from the memory device and communication of the data to the host system.

The memory device may include a plurality of wordlines. The plurality of wordlines may be organized into a plurality of virtual block. Each of the wordlines may store data associated with a corresponding namespace. Data for a corresponding namespace may be stored in more than one virtual block. The data of each namespace may have an associated VDF count. The data may correspond to the incoming data described with respect to the operations of the method 900.

At operation 1102, separate VDF counts for each namespace may be maintained. Each VDF count may be a number of VDFs for a given namespace for respective ones of the virtual blocks. For example, the controller may maintain a first VDF count for data of a first namespace stored in a first virtual block of the plurality of virtual blocks and a second VDF count for data of the first namespace stored in a second virtual block of the plurality of virtual blocks. Some namespaces of the plurality of namespaces may have data stored in only one virtual block. Other namespaces of the plurality of namespaces may have data stored in more than one virtual block of the plurality of virtual blocks. The controller may receive a data erase request from the host system to erase data for a particular namespace.

At operation 1104, a namespace format command may be received from the host system. The namespace format command may include a user data erase request. The user data erase request may include a request to erase user data for a first namespace of the plurality of namespaces.

At operation 1106, the VDF count for the first namespace may be set to zero (0) for one or more of the respective ones of the plurality of virtual blocks. For example, the first VDF count for the data of the first namespace may be set to zero (0) and the second VDF count for the data of the first namespace may be set to zero (0). Setting the VDF count(s) to zero (0) may ensure fast format command processing compared to conventional operations.

According to various examples of the present disclosure, a data storage system includes a memory device and a controller. The memory device includes a plurality of wordlines. The controller includes processor(s) and a memory. The memory includes instructions, that when executed the processor(s), cause the processor(s) to: identify, from incoming data, a plurality of namespace identifiers (IDs) corresponding to a plurality of namespaces; segregate the incoming data according to the plurality of namespace IDs; and write the segregated incoming data to respective ones of the plurality of wordlines.

In combination with any of the previous examples, the instructions, when executed by the processor(s), cause the processor(s) to: issue a single state program command to erase or corrupt the plurality of wordlines to a same state.

In combination with any of the previous examples, the instructions, when executed by the processor(s), cause the processor(s) to: receive a namespace format command for a first namespace of the plurality of namespaces, said namespace format command including a user data erase request for the first namespace; identify a first wordline of the plurality of wordlines associated with the first namespace; and responsive to receiving the namespace format command, issue a single state program command to erase the plurality of wordlines to a same state.

In combination with any of the previous examples, the same state may be a highest state of a plurality of states.

In combination with any of the previous examples, the plurality of wordlines may be organized into a plurality of virtual blocks. The instructions, when executed by the processor(s), cause the processor(s) to: maintain respective VDF counts for each of the plurality of namespaces for respective ones of the plurality of virtual blocks; receive a namespace format command for a first namespace of the plurality of namespaces; and responsive to receiving the namespace format command, set the VDF count for the first namespace to zero (0) for one or more of the respective ones of the plurality of virtual blocks..

According to various examples of the present disclosure, a computer-implemented method may include: identifying, from incoming data, a plurality of namespace identifiers (IDs) corresponding to a plurality of namespaces; segregating the incoming data according to the plurality of namespace IDs; and writing the segregated incoming data to respective ones of a plurality of wordlines of a memory device.

According to various examples of the present disclosure, non-transitory computer readable media may include instructions stored thereon, that when executed by processor(s), cause the processor(s) to: identify, from incoming data, a plurality of namespace identifiers (IDs) corresponding to a plurality of namespaces; segregate the incoming data according to the plurality of namespace IDs; and write the segregated incoming data to respective ones of a plurality of wordlines of a memory device.

In combination with any of the previous examples, the instructions, when executed by the processor(s), cause the processor(s) to: receive a namespace format command for a first namespace of the plurality of namespaces, said namespace format command including a user data erase request for the first namespace; and responsive to receiving the namespace format command, issue a single state program command to erase or corrupt the plurality of wordlines to a same state.

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. Non-transitory computer readable media having instructions stored thereon, that when executed by at least one processor, cause the at least one processor to:
identify, from incoming data, a plurality of namespace identifiers (IDs) corresponding to a plurality of namespaces;
segregate the incoming data according to the plurality of namespace IDs; and
write the segregated incoming data to respective ones of a plurality of wordlines of a memory device.

2. The non-transitory computer readable media of claim 1,
wherein the instructions, when executed by the at least one processor, cause the at least one processor to:
issue a single state program command to erase or corrupt the plurality of wordlines to a same state.

3. The non-transitory computer readable media of claim 2, wherein the same state is a highest state of a plurality of states.

4. The non-transitory computer readable media of claim 1,
wherein the instructions, when executed by the at least one processor, cause the at least one processor to:
receive a namespace format command for a first namespace of the plurality of namespaces, said namespace format command including a user data erase request for the first namespace;
identify a first wordline of the plurality of wordlines associated with the first namespace; and
responsive to receiving the namespace format command, issue a single state program command to erase the first wordline to a same state.

5. The non-transitory computer readable media of claim 4, wherein the same state is a highest state of a plurality of states.

6. The non-transitory computer readable media of claim 1,
said plurality of wordlines being organized into a plurality of virtual blocks,
wherein the instructions, when executed by the at least one processor, cause the at least one processor to:
maintain respective valid data frame (VDF) counts for each of the plurality of namespaces for respective ones of the plurality of virtual blocks;
receive a namespace format command for a first namespace of the plurality of namespaces; and
responsive to receiving the namespace format command, set the VDF count for the first namespace to zero (0) for one or more of the respective ones of the plurality of virtual blocks.

7. A data storage system comprising:
a memory device including a plurality of wordlines; and
a controller including at least one processor and a memory, said memory including instructions stored thereon, that when executed by the at least one processor, cause the at least one processor to:
identify, from incoming data, a plurality of namespace identifiers (IDs) corresponding to a plurality of namespaces;
segregate the incoming data according to the plurality of namespace IDs; and
write the segregated incoming data to respective ones of the plurality of wordlines.

8. The data storage system of claim 7,
wherein the instructions, when executed by the at least one processor, cause the at least one processor to:
receive a namespace format command for a first namespace of the plurality of namespaces, said namespace format command including a user data erase request for the first namespace; and
responsive to receiving the namespace format command, issue a single state program to erase the plurality of wordlines to a same state.

9. The data storage system of claim 8, wherein the same state is a highest state of a plurality of states.

10. The data storage system of claim 7,
wherein the instructions, when executed by the at least one processor, cause the at least one processor to:
receive a namespace format command for a first namespace of the plurality of namespaces, said namespace format command including a user data erase request for the first namespace;
identify a first wordline of the plurality of wordlines associated with the first namespace; and
responsive to receiving the namespace format command, issue a single state program command to erase the first wordline to a same state.

11. The data storage system of claim 10, wherein the same state is a highest state of a plurality of states.

12. The data storage system of claim 7,
said plurality of wordlines being organized into a plurality of virtual blocks,
wherein the instructions, when executed by the at least one processor, cause the at least one processor to:
maintain respective valid data frame (VDF) counts for each of the plurality of namespaces for respective ones of the plurality of virtual blocks.

13. The data storage system of claim 12,
wherein the instructions, when executed by the at least one processor, cause the at least one processor to:
issue a namespace format command for a first namespace of the plurality of namespaces; and
in response to issuing the namespace format command, set the VDF count for the first namespace to zero (0) for one or more of the respective ones of the plurality of virtual blocks.

14. A computer-implemented method, comprising:
identifying, from incoming data, a plurality of namespace identifiers (IDs) corresponding to a plurality of namespaces;
segregating the incoming data according to the plurality of namespace IDs; and
writing the segregated incoming data to respective ones of a plurality of wordlines of a memory device.

15. The computer-implemented method of claim 14, comprising:
issuing a single state program command to erase the plurality of wordlines to a same state.

16. The computer-implemented method of claim 15, wherein the same state is a highest state of a plurality of states.

17. The computer-implemented method of claim 14, comprising:
receiving a data erase request associated with a first namespace of the plurality of namespaces;
identifying a first wordline of the plurality of wordlines associated with the first namespace; and
issuing a single state program command to erase the first wordline to a same state.

18. The computer-implemented method of claim 17, wherein the same state is a highest state of a plurality of states.

1919 The computer-implemented method of claim 14,
said plurality of wordlines being organized into a plurality of virtual blocks, the method comprising:
maintaining respective valid data frame (VDF) counts for each of the plurality of namespaces for respective ones of the plurality of virtual blocks.

20. The computer-implemented method of claim 19, comprising:
receiving a namespace format command for a first namespace of the plurality of namespaces, said namespace format command including a user data erase request for the first namespace;
issuing a namespace format command for a first namespace of the plurality of namespaces; and
responsive to receiving the namespace format command, setting the VDF count for the first namespace to zero (0) for one or more of the respective ones of the plurality of virtual blocks.
